(19) United States
(12) Patent Application Publication
(10) Pub. No.: US 2006/0017321 A1
(43) Pub. Date: Jan. 26, 2006

(54) Vehicle brake hydraulic pressure controller

(76) Inventor: Takao Tsunooka, Kariya (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/179,526

(22) Filed: Jul. 13, 2005

(30) Foreign Application Priority Data
Jul. 20, 2004 (JP) 2004-211985

(51) Int. Cl. B60T 8/36

(52) U.S. Cl. 303/119.3

(57) ABSTRACT

A vehicle brake hydraulic pressure controller includes a housing, a plurality of hydraulic pressure control valves mounted in the housing, and an electronic control unit for controlling the hydraulic pressure control valves. The electronic control unit includes a casing and a circuit board mounted in the casing so as to oppose the hydraulic pressure control valves. The circuit board carries a control circuit for controlling the hydraulic pressure control valves. The respective hydraulic pressure control valves are connected to the control circuit through bus bars embedded in a partitioning wall provided between the casing and the housing. The bus bars extend substantially along, while being spaced apart from, the surface of the circuit board facing the hydraulic pressure control valves so as to be connected to the control circuit at a plurality points in a limited, concentrated area of the circuit board near the peripheral area of the circuit board.

### BACKGROUND OF THE INVENTION

The present invention relates to a brake hydraulic pressure controller mounted in a vehicle hydraulic brake system including a hydraulic brake booster (HB), an anti-lock brake system (ABS) and/or a vehicle stability control system (VSC).

As shown in FIG. 7 (and as disclosed in JP patent publication 2001-260846), the brake hydraulic pressure controller (designated by numeral 3) of such a vehicle hydraulic system is disposed between a brake pedal 1 and brake wheel cylinders 4 (4a, 4b, 4c and 4d). The brake hydraulic pressure controller 3 includes pressure increasing control valves and pressure reducing control valves. By selectively closing and opening the respective control valves, hydraulic pressures in the individual brake wheel cylinders 4 can be controlled.

Many of today's vehicle hydraulic brake systems have an anti-lock brake function, a vehicle stability control function, etc. Such functions necessitate an increased number of parts of e.g. the brake hydraulic pressure controller 3. Still, it is desired or required that the brake hydraulic controller 3 and other units or devices be as small as possible.

There are various types of brake hydraulic pressure controllers, including the one shown in FIGS. 7 and 8. The brake hydraulic pressure controller 3 shown in FIGS. 7 and 8 is a part of a hydraulic brake booster. The hydraulic brake booster includes a master cylinder 2 having a piston rod 5a coupled to the brake pedal 1. The master cylinder 2 has a body 6 which is integral with a housing 10 of the brake hydraulic pressure controller 3. The controller 3 includes various types of hydraulic pressure control valves 11 mounted in its housing 10. Pipes r extend from the body 6 to the front and rear brake wheel cylinders. (This type of hydraulic brake booster is disclosed in JP patent publication 08-11696.)

In this hydraulic brake booster, when the brake pedal 1 is depressed or released, hydraulic fluid a in the master cylinder is supplied into the brake wheel cylinders 4 or hydraulic fluid a is discharged from the wheel cylinders 4. When the respective hydraulic pressure control valves 11 are turned on or off by an electronic control unit 20 of the brake hydraulic pressure controller 3, too, hydraulic fluid a is supplied into or discharged from the brake wheel cylinders 4. Thus, the hydraulic pressure in the wheel cylinders 4 can be controlled both manually through the brake pedal 1 and by the electronic control unit 20. When hydraulic fluid a is supplied into the brake wheel cylinders 4, hydraulic fluid is replenished into the brake hydraulic pressure controller 3 from an accumulator 6a by activating a pump 7 with a motor 8. Hydraulic fluid returned into the brake hydraulic pressure controller 3 flows back into a reservoir 9.

Typically, the hydraulic pressure control valves 11 are mounted in the housing 10 in a plurality of rows as shown in FIG. 9. The electronic control unit 20 for controlling the valves 11 is mounted on the outside of the housing 10. The electronic control unit 20 includes a casing 21. A control circuit board 22 for controlling the hydraulic pressure control valves 11 is mounted in the casing 21.

Typically, as shown in FIGS. 9 and 10, each hydraulic pressure control valve 11 has its coil connected to a control circuit on the circuit board 22 through connecting pieces 23 extending vertically from the valve 11 through the circuit board 22 and connected to its control circuit. (This type of hydraulic pressure controller is disclosed in JP patent publication 11-165627, particularly its FIG. 7.)

In this arrangement, as shown in FIG. 10, the connecting pieces 23 are soldered to the control circuit in areas e that are dispersed from one another. Since the soldering areas e are dispersed from one another, large electronic parts such as a microcomputer M cannot be mounted on the circuit board 22 in its area defined by one-dot chain line in FIG. 10. Even small electronic parts D cannot be easily mounted in the area defined by the one-dot chain line because of the presence of dispersed soldering areas e. Thus, it is necessary to increase the size of the circuit board 22 so that the electronic parts D and the microcomputer M can be mounted on the circuit board 22 in its area other than the area defined by the one-dot chain line.

Today's brake hydraulic pressure controllers of e.g. hydraulic brake booster include a large number of (e.g. 12) hydraulic pressure control valves 11, and also carry many electronic parts D including microcomputers M on its circuit board 22. Thus, if the connecting pieces 23 are connected to the circuit board 22 in the manner as described above with reference to FIG. 10, it is necessary to prepare a large circuit board 22 having a large surface area to mount a greater number of electronic parts D including microcomputers M. This leads to an increase in the size of the casing 21 and thus an increase in the size of the entire brake hydraulic pressure controller 3.

Because today's vehicles have a large number of parts and devices, it is required that these parts and devices be as small as possible. The brake hydraulic pressure controller 3 has to be also as small as possible.

An object of the present invention is to provide a brake hydraulic pressure controller which includes large numbers of hydraulic pressure control valves, electronic parts and microcomputers and is still sufficiently small in size.

### SUMMARY OF THE INVENTION

According to this invention, there is provided a vehicle brake hydraulic pressure controller comprising a housing, a plurality of hydraulic pressure control valves mounted in the housing, and an electronic control unit for controlling the hydraulic pressure control valves, the electronic control unit comprising a casing and a circuit board mounted in the casing so as to oppose the hydraulic pressure control valves, the circuit board carrying a control circuit for controlling the hydraulic pressure control valves, the respective hydraulic pressure control valves being connected to the control circuit through connecting lines, the connecting lines having portions that extend substantially along, while being spaced apart from, a surface of the circuit board facing the hydraulic pressure control valves, whereby the connecting lines are connected to the control circuit at a plurality points in a limited, concentrated area of the circuit board.

Since the connecting lines are connected to the control circuit at a plurality of points in a limited, concentrated area of the circuit board, it is possible to reduce the distances between the adjacent terminals to a minimum. Thus, this limited, concentrated area of the circuit board is far smaller than the area defined by the one-dot chain line shown in FIG. 10, where the simple vertical connecting pieces 23 are soldered to the control circuit of the circuit board.

In FIG. 10, electronic parts D including the microcomputers M cannot usually be mounted near the peripheral area c defined by the two-dot chain line. According to the present invention, the connecting lines are arranged such that the areas e where the electronic parts D cannot be mounted are disposed near the peripheral area c or otherwise in a limited, concentrated area or areas. Thus, a sufficiently large space remains on the circuit board 22 where electronic parts D including microcomputers M can be mounted without the need to increase the size of the circuit board 22.

In order to simplify the connecting lines, the connecting points at which the connecting lines are connected to the control circuit on the circuit board may be disposed in a plurality of limited, concentrated area such that each area is located close to one of the hydraulic pressure control valves.

From another aspect of the invention, there is provided a vehicle brake hydraulic pressure controller comprising a housing, a plurality of hydraulic pressure control valves mounted in the housing, and an electronic control unit for controlling the hydraulic pressure control valves, the electronic control unit comprising a casing and a circuit board mounted in the casing so as to oppose the hydraulic pressure control valves, the circuit board carrying a control circuit for controlling the hydraulic pressure control valves, the respective hydraulic pressure control valves being connected to the control circuit through connecting lines, the connecting lines extending from the respective hydraulic pressure control valves along a surface of the circuit board facing the hydraulic pressure control valves, while being spaced apart from the surface, to points near a peripheral edge of the circuit board, and then guided onto the circuit board and connected to the control circuit.

Each of the hydraulic pressure control valves may be connected to the control circuit at a plurality of points of the circuit board.

The connecting lines may comprise bus bars mounted to a partitioning wall provided between the casing and the housing.

The bus bars may be embedded in the partitioning wall, or bonded to the front or back side of the partitioning wall.

The partitioning wall may be omitted. In this case, the bus bars are supported by the casing so as to extend substantially along, while being spaced apart from, a surface of the circuit board facing the hydraulic pressure control valves.

The control circuit on the circuit board to which the connecting lines are connected may be formed on either side of the circuit board.

### BRIEF DESCRIPTION OF THE DRAWINGS

Other features and objects of the present invention will become apparent from the following description made with reference to the accompanying drawings, in which:

FIG. 1 is a partially cutaway front view of a first embodiment;

FIG. 2 is a sectional view taken along line A-A of FIG. 1;

FIG. 3 is a sectional view taken along line B-B of FIG. 1;

FIGS. 4A and 4B are views similar to FIG. 3 and showing the bus bars in the top wall 13a;

FIG. 5 is a schematic plan view of a second embodiment;

FIG. 6 is a schematic plan view of a third embodiment;

FIG. 7 is a schematic view of a vehicle hydraulic brake system;

FIG. 8 is a schematic perspective view of a brake hydraulic pressure controller in a hydraulic brake booster;

FIG. 9 is a partially cutaway front view of a conventional brake hydraulic pressure controller; and

FIG. 10 is a schematic plan view of the conventional controller of FIG. 9.

### DETAILED DESCRIPTION OF THE PREFERRED EMBODIMENTS

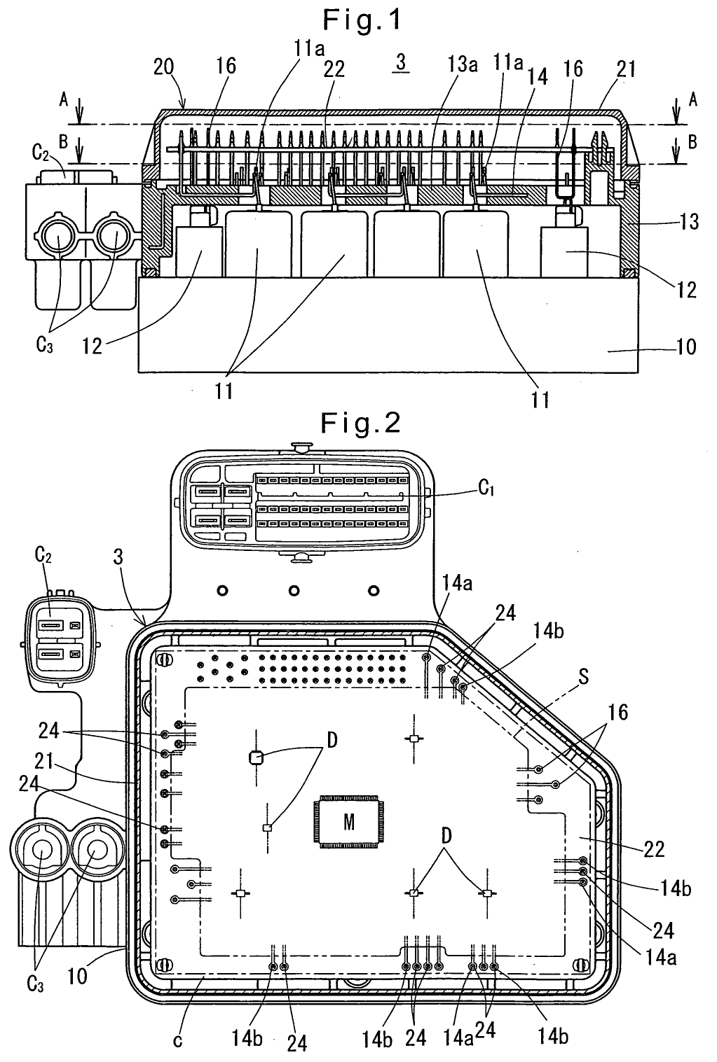

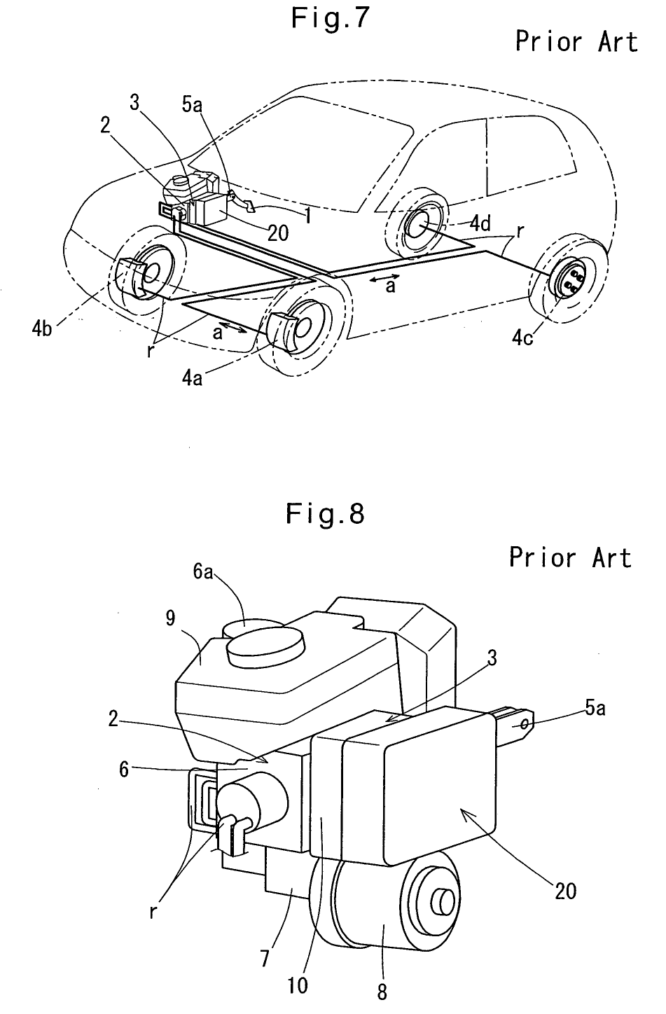

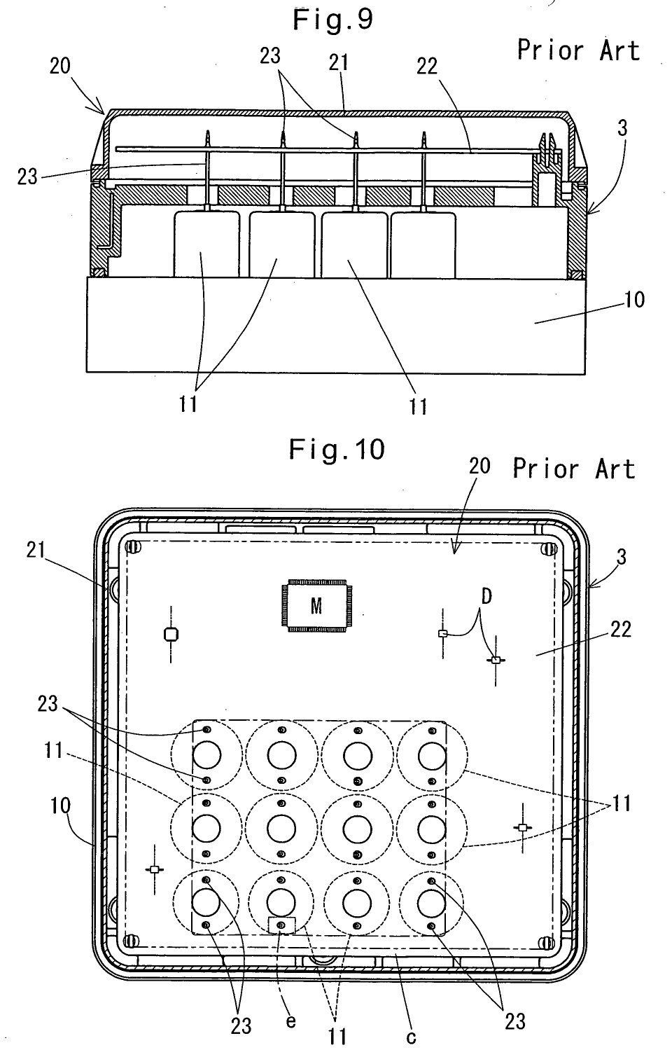

FIGS. 1-3 show the first embodiment, which is a brake hydraulic pressure controller 3 of a hydraulic brake booster of the same type as shown in FIG. 7. Thus, elements similar or identical to elements shown in FIG. 7 are denoted by identical numerals. Like the controller of FIG. 7, the controller 3 of the embodiment includes a housing 10 in which are mounted a plurality of hydraulic pressure control valves 11 and sensors 12 in a plurality of rows. An electronic control unit 20 for controlling the hydraulic pressure control valves 11 is mounted on the outer surface of the housing 10. The electronic control unit 20 includes a casing 21 in which a circuit board 22 for controlling the hydraulic pressure control valves 11 is mounted.

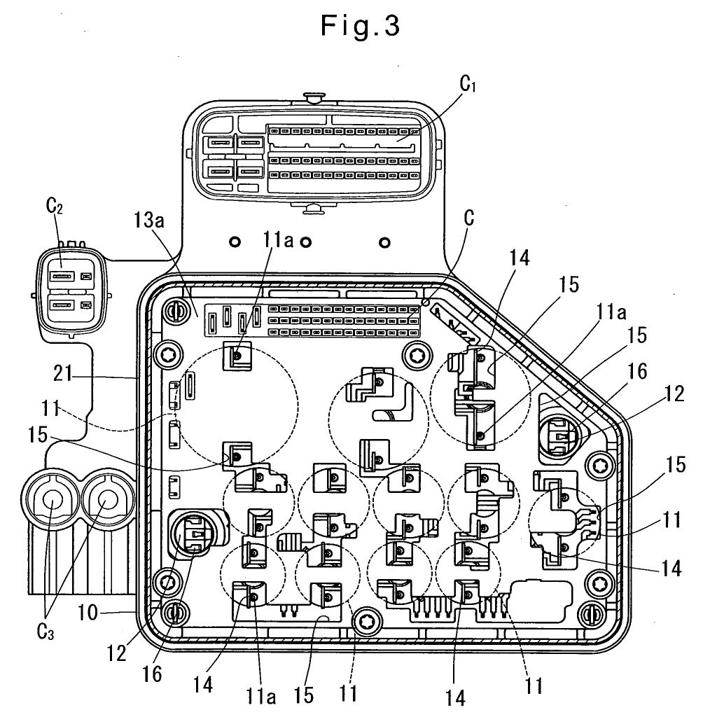

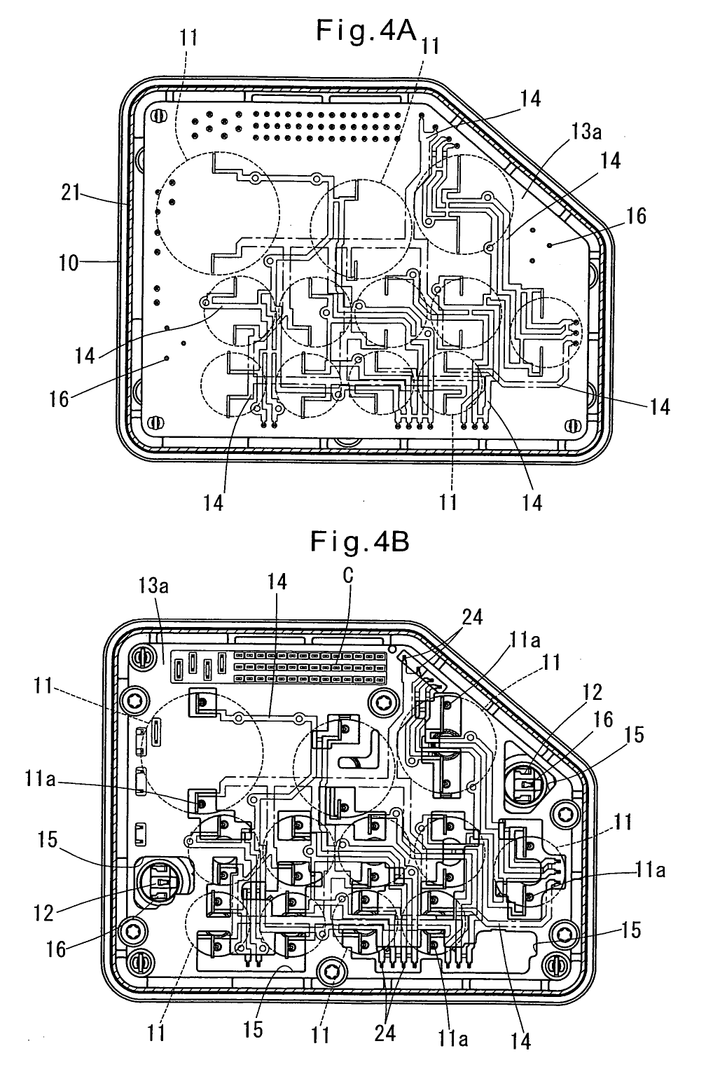

The controller 3 includes a plastic case 13 coupled to the housing 10. When the case 13 is formed, bus bars 14 are embedded in a top wall 13a of the case 13. Through the bus bars 14, the respective hydraulic pressure control valves 11 are connected to the circuit board 22. The top wall 13a is formed with holes 15 each facing one of the hydraulic pressure control valves 11 and sensors 12. From the sensors 12, connecting pieces 16 extend vertically through the corresponding holes 15 and the circuit board 22, and are electrically connected to respective terminals 24 of a control circuit on the circuit board 22 (see FIGS. 3 and 4B).

The bus bars 14 have first ends that protrude into the holes 15 facing the respective hydraulic pressure control valves 11 and are electrically connected to coils of the respective valves 11 at points 11a (see FIGS. 1 and 3). As shown in FIGS. 3, 4A and 4B, the bus bars 14 extend from the first ends through the top wall 13a of the case 13, which separates the electronic control unit 20 from the housing 10, to points near the peripheral area c of the circuit board 22 shown in FIG. 2. At these points, the bus bars 14 are bent vertically and soldered to terminals 24 of the control circuit on the circuit board 22 near the peripheral area c. The terminals 24 to which the bus bars 14 are connected should be provided as close to the respective hydraulic pressure control valves 11 as possible.

The control circuit, which comprise electronic parts D including microcomputers M, is not shown, and is formed in an area S defined by two-dot chain line in FIG. 2. A connector C shown in FIG. 3 is connected to an external connector C1 which is connected to a power source and/or sensors. A connector C2 is connected to a power source. A connector C3 is connected to a motor 8. These connectors are also connected to the respective terminals 24 on the circuit board 22. FIG. 4A shows the bus bars 14 with the holes 15 of the top walls 13a omitted so as to clearly show the position of the bus bars 14 relative to the circuit board 22. FIG. 4B is similar to FIG. 3 but further shows the portions of the bus bars 14 embedded in the top wall 13a by phantom line so as to facilitate understanding on how the bus bars 14 are connected to the coils of the respective hydraulic pressure control valves 11.

In the embodiment, each hydraulic pressure valve 11 has one of its electrodes connected to a pair of terminals 24 on the circuit board through one of the bus bars 14 and the other electrode connected to a pair of terminals 24 on the circuit board 22 through several bus bars 14. In this hydraulic brake booster, when the brake pedal 1 is depressed or released, hydraulic fluid a in the master cylinder is supplied into the brake wheel cylinders 4 or hydraulic fluid a is discharged from the wheel cylinders 4. When the respective hydraulic pressure control valves 11 are turned on or off by the electronic control unit 20 of the brake hydraulic pressure controller 3, too, hydraulic fluid a is supplied into or discharged from the brake wheel cylinders 4. Thus, the hydraulic pressure in the wheel cylinders 4 can be controlled both manually through the brake pedal 1 and by the electronic control unit 20.

In this embodiment, as will be apparent from FIGS. 2 to 4B, the bus bars 14 extend from the respective hydraulic pressure control valves 11 to points near the peripheral area c and connected to the terminals 24. The area S, which is large enough to mount all of the necessary electronic parts D including microcomputers M, is defined inside of the terminals 24. Thus, the necessary electronic parts D including microcomputers M can be mounted on the circuit board 22 without the need to increase the size of the circuit board 22 and thus the size of the electronic control unit 20 as well as the size of the entire brake hydraulic pressure controller 3.

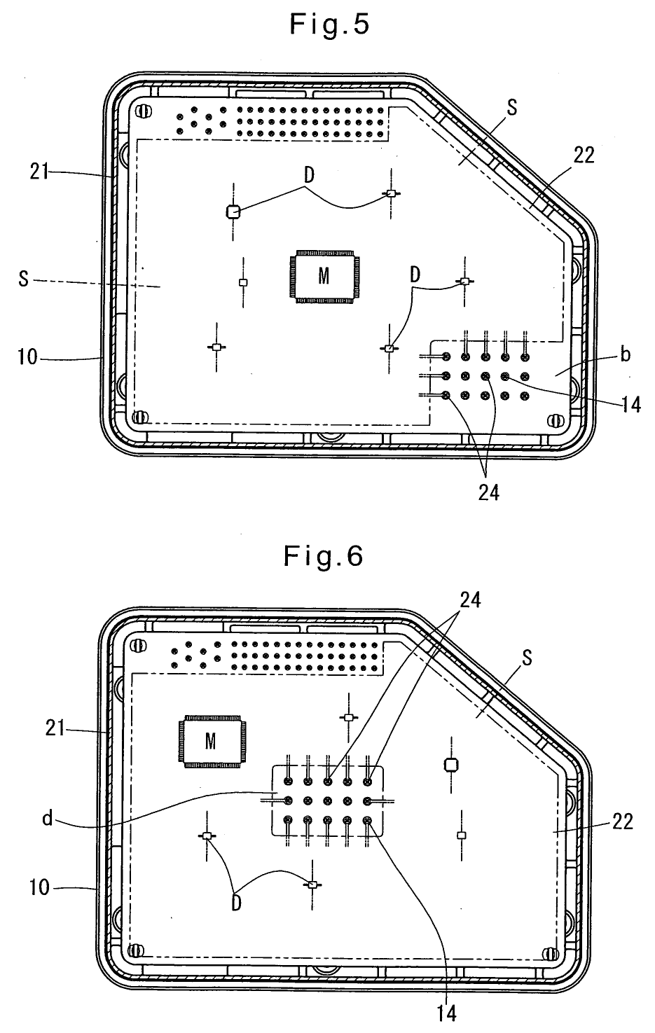

In the embodiment of FIGS. 1 to 4, the bus bars 14 are arranged so as to be connected to the terminals 24 near the peripheral area c. But instead, the bus bars 14 may be arranged so as to be connected to the terminals 24 in a corner area b of the circuit board 22 as shown in FIG. 5, or in a central area d of the circuit board 22 as shown in FIG. 6, or any other limited, concentrated area of the circuit board 22.

The brake hydraulic pressure controller 3 of the embodiment is a controller of a hydraulic brake booster. But the brake hydraulic pressure controller according to the present invention is not limited thereto. For example, it may comprise the housing 10, two electronic control units each mounted on one of two opposed sides of the housing 10, and two motors each mounted on one of the two opposed sides of the housing 10.

What is claimed is:

1. A vehicle brake hydraulic pressure controller comprising a housing, a plurality of hydraulic pressure control valves mounted in said housing, and an electronic control unit for controlling said hydraulic pressure control valves,
said electronic control unit comprising a casing and a circuit board mounted in said casing so as to oppose said hydraulic pressure control valves, said circuit board carrying a control circuit for controlling said hydraulic pressure control valves, said respective hydraulic pressure control valves being connected to said control circuit through connecting lines, said connecting lines having portions that extend substantially along, while being spaced apart from, a surface of said circuit board facing said hydraulic pressure control valves, whereby said connecting lines are connected to said control circuit at a plurality points in a limited, concentrated area of said circuit board.

2. A vehicle brake hydraulic pressure controller comprising a housing, a plurality of hydraulic pressure control valves mounted in said housing, and an electronic control unit for controlling said hydraulic pressure control valves,
said electronic control unit comprising a casing and a circuit board mounted in said casing so as to oppose said hydraulic pressure control valves, said circuit board carrying a control circuit for controlling said hydraulic pressure control valves, said respective hydraulic pressure control valves being connected to said control circuit through connecting lines, said connecting lines extending from said respective hydraulic pressure control valves along a surface of said circuit board facing said hydraulic pressure control valves, while being spaced apart from said surface, to points near a peripheral edge of said circuit board, and then guided onto said circuit board and connected to said control circuit.

3. The vehicle brake hydraulic pressure controller of claim 2 wherein each of said hydraulic pressure control valves is connected to said control circuit at a plurality of points of said circuit board.

4. The vehicle brake hydraulic pressure controller of claim 1 wherein said connecting lines comprise bus bars mounted to a partitioning wall provided between said casing and said housing.

5. The vehicle brake hydraulic pressure controller of claim 3 wherein said connecting lines comprise bus bars mounted to a partitioning wall provided between said casing and said housing.
